(19) United States
(12) Patent Application Publication
(10) Pub. No.: US 2026/0062330 A1
(43) Pub. Date: Mar. 5, 2026

(54) BIOREMEDIATION OF ORGANIC COMPOUNDS IN WATER VIA MICROALGAE

(71) Applicant: KING FAHD UNIVERSITY OF PETROLEUM AND MINERALS, Dhahran (SA)

(72) Inventors: Shaikh Abdur RAZZAK, Dhahran (SA); Mohammed Omar FARUQUE, Dhahran (SA); Mohammad Mozahar HOSSAIN, Dhahran (SA)

(73) Assignee: KING FAHD UNIVERSITY OF PETROLEUM AND MINERALS, Dhahran (SA)

(21) Appl. No.: 18/890,381

(22) Filed: Sep. 19, 2024

(30) Foreign Application Priority Data
Sep. 4, 2024 (SA) 1020244915

(51) Int. Cl. C02F 3/32; C02F 101/32; C02F 101/38

(52) U.S. Cl. CPC C02F 3/322; C02F 2101/32; C02F 2101/38; C02F 2203/006

(57) ABSTRACT

A method for organic compound removal from a solution using microalgae includes extracting one or more hydrocarbons from an underground geologic formation to form a hydrocarbon composition and a produced water including at least a portion of the one or more hydrocarbons and one or more salts. The method further includes mixing the produced water with a wastewater to form a solution, and then contacting a microalgae feedstock, Chlorella sorokiniana, with the solution in a bioreactor. The total lipid content of the microalgae feedstock is 13 to 17%. The method includes removing the one or more hydrocarbons, nitrogen, and phosphorous from the solution by algal consumption with the microalgae feedstock. The method of the present disclosure removes 80 to 90 wt. % of the one or more hydrocarbons, 70 to 85 wt. % nitrogen, and 90 to 100 wt. % phosphorous.

### CROSS-REFERENCE TO RELATED APPLICATIONS

The present disclosure claims the benefit of Saudi patent application Ser. No. 1020244915, filed on Sep. 4, 2024, with the Saudi Authority for Intellectual Property Office, which is incorporated herein by reference in its entirety.

### STATEMENT OF ACKNOWLEDGEMENT

Support provided by the Interdisciplinary Research Center for Refining and Advanced Chemicals, King Fahd University of Petroleum and Minerals, Saudi Arabia, through Project INRC2404 is gratefully acknowledged.

### BACKGROUND

### Technical Field

The present disclosure is directed to a method and system for the bioremediation of organic compounds and, more particularly, to a method for removing organic compounds from a solution using a halotolerant microalgae, Chlorella sorokiniana.

### Description of Related Art

The “background” description provided herein is to generally present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The oil and gas sector contributes to fulfill global energy needs; however, the oil and gas sector also generates substantial volumes of wastewater. The wastewater created during oil or gas extraction from subsurface reservoirs is known as petroleum-derived produced water (PW). Produced water is a waste stream by-product, representing up to 80% of all waste produced by the oil and gas sector. Around 250 million barrels of PW are produced daily, compared to 80 million barrels of oil [Das, N., Rajput, H., Aly Hassan, A., and Kumar, S., Application of Different Coagulants and Cost Evaluation for the Treatment of Oil and Gas Produced Water, Water, 2023, 15, 3, 464]. The ratio between PW generation and oil extraction from reservoirs is about 3:1. Possibly due to the aging of oil wells, the ratio may approach 12:1 by 2025 [Cavalcanti Pessoa, et al., A review of microalgae-based biorefineries approach for produced water treatment: Barriers, pretreatments, supplementation, and perspectives, J. Environ. Chem. Eng., 2022, 10, 4]. It is, therefore, economically favorable and environmentally beneficial to reuse PW; however, PW is not suited for surface discharge, disposal in groundwater resources, or re-use for other uses due to the presence of hazardous hydrocarbons, dissolved salts, heavy metals, and other pollutants. The release of PW into the environment threatens ecosystems, human health, and aquatic life. An environmentally responsible PW treatment may assist the oil and gas industry to be more ecological, comply with environmental standards, and allow for the re-use and recycling of PW.

Geological properties, contents, and features of naturally appearing chemical compounds in PW of geologic reservoirs are related. PW is constituted of hazardous organic pollutants (such as phenols), organic acids, inorganic pollutants (such as total dissolved solids (TDS)), heavy metals (HMs), chemical additives utilized in the production of oil and gas (such as benzene, toluene, ethylbenzene, and xylenes (BTEX)), polycyclic aromatic hydrocarbons (PAHs), as well as other pollutants that are harmful to the environment. Untreated or insufficiently treated PW discharged into bodies of water may destabilize ecosystems and destroy marine life. Conservative treatment procedures have been employed to decontaminate PW for a while; however, they have failed to comply with environmental laws, particularly in the area of water reuse.

Organic acids and phenols in the dissolved organic carbon fraction, even at low concentrations, are the most toxic organic components in PW to aquatic, human, and plant life. Physical, chemical, and biological techniques are frequently applied combinatorially and sequentially during PW treatment to achieve removal and align with environmental regulations. Within the biological category, techniques with organisms have been utilized to remove soluble organic contaminants from PW [S. Mohammad, A. Ojagh, N. Fallah, and B. Nasernejad, Biological treatment of organic compounds in produced water with use of halotolerant bacteria, J. Environ. Chem. Eng., 2020, 8, 6, 104412]. Despite having different methods for removing dissolved organic carbon from PW, microalgae-based bioremediation processes for dissolved organic pollutant removal from PW may be an acceptable approach as it is cost-effective, environmentally benign, and does not require any supplementary energy. Microalgae may be favored over conventional biological wastewater treatment methods for their benefits of enhanced elimination of pollutants and pathogens, reduced energy consumption, cost-efficiency, decreased sludge formation, nutrient recycling, mitigation of greenhouse gas emissions, and valuable biomass production through nutrient recovery.

Microalgae is a diverse group of photosynthetic microorganisms and a promising group of bioremediation agents, owing to their rapid growth, versatility, and unique capacity to thrive in extreme conditions, including high salinity. Biotechnologies that are based on microalgae are considered to be a self-sustaining treatment. Mixotrophic microorganisms can perform photosynthesis. To sustain their growth, they take in CO₂ and use sunlight as an energy source. In addition, they can derive energy from organic carbons present in PW, which results in a decrease in the quantity of organic carbon (COD, TOC) present in PW when it is utilized as a medium for culture [V. Matamoros, R. Gutiérrez, I. Ferrer, J. García, and J. M. Bayona, Capability of microalgae-based wastewater treatment systems to remove emerging organic contaminants: a pilot-scale study, J. Hazard. Mater., 2023, 15, 2, 1409]. Mixing domestic wastewater, which contains nitrogen and phosphorous, reduced the barrier to algae development and enhanced biomass production, reducing the expense of artificial chemicals frequently utilized as a source of nutrients. By combining PW with a nutrient-rich effluent, it may be feasible to enhance the accessibility of nutrients for algal development while reducing the concentration of detrimental components that may exist in PW. In addition to the advantages of diluting harmful substances in PW, combining domestic wastewater may also serve as an option to decrease salinity in PW, which has been an obstacle in utilizing PW for cultivating algae.

In this context, halotolerant microalgae can adapt and grow in saline environments, making them favorable for the treatment of produced water (PW), which is often characterized by elevated salinity levels, including a total dissolved solids (TDS) level of around 7744 mg/L to 38,000 mg/L. Petroleum-derived PW effluents may be cleaned up using halotolerant microalgae strains; therefore, freshwater halotolerant microalgae may be used for the bioremediation of dissolved organic compounds and nutrient removal in PW.

The development of photosynthetic microorganisms in PW to create biomass and possibly recycle and/or bioremediate the waste has been studied; however, no study has been conducted yet to remove the dissolved organic carbon from PW using the microalgae Chlorella sorokiniana. Thus, a need arises to devise a better and more efficient method to utilize Chlorella sorokiniana as a potential halotolerant mixotrophic microalgae to bioremediate the dissolved organic carbon in PW.

An object of the present disclosure is to provide a method for removing organic compounds from a solution using a halotolerant microalgae, Chlorella sorokiniana, that may circumvent and overcome drawbacks of the present art.

### SUMMARY

In an exemplary embodiment, a method for organic compound removal from a solution is described. The method includes extracting one or more hydrocarbons from an underground geologic formation, as such, extracting the one or more hydrocarbons forms a hydrocarbon composition and a produced water. The produced water includes at least a portion of the one or more hydrocarbons and one or more salts. The method further includes mixing the produced water with a domestic wastewater to form a solution, contacting a microalgae feedstock with the solution in a bioreactor, as such the microalgae feedstock is a Chlorella sorokiniana. The produced water includes an acetate and the domestic wastewater includes nitrogen and phosphorous. Furthermore, the method includes removing the one or more hydrocarbons, nitrogen, and phosphorous from the solution by algal consumption with the microalgae feedstock, a total lipid content of the microalgae feedstock is 13% to 17% based on a dry weight of biomass. The one or more hydrocarbons are removed in an amount of 80 percent by weight (wt. %) to 90 wt. % based on a total weight of the one or more hydrocarbons in the solution before the removing. The nitrogen is removed in an amount of 70 wt. % to 85 wt. % based on a total weight of the nitrogen in the solution before the removing, as such, the phosphorous is removed in an amount of 90 wt. % to 100 wt. % based on a total weight of the phosphorus in the solution before the removing.

In some embodiments, the method includes contacting the microalgae feedstock with the solution in a bioreactor for 1 days to 20 days.

In some embodiments, the one or more salts are a sodium salt, a calcium salt, a magnesium salt, a potassium salt, a sulfate, and a strontium salt.

In some embodiments, the produced water has a total dissolved solids value of 25000 milligrams per liter (mg/L) to 25500 mg/L.

In some embodiments, the produced water has a salinity of 39200 mg/L to 39600 mg/L. In some embodiments, the produced water has an electrical conductivity of 50 milli siemens per centimeter (mS/cm) to 70 mS/cm.

In some embodiments, the produced water has a total organic carbon value of 330 mg/L to 350 mg/L.

In some embodiments, a volume ratio of the produced water to the domestic wastewater is 5:95 to 55:45 based on a total volume of the solution.

In some embodiments, the microalgae feedstock is pre-adapted.

In some embodiments, a maximal optical density of the Chlorella sorokiniana at a wavelength of 680 nanometers (nm) is from 3.2 to 5.2.

In some embodiments, a maximum specific growth rate of the Chlorella sorokiniana is from 0.14 per day (day-1) to 0.25 day⁻¹.

In some embodiments, a maximum biomass productivity of the Chlorella sorokiniana is from 45 mg/L to 55 mg/L per day.

In some embodiments, a biomass output of the Chlorella sorokiniana after 15 to 17 days of contacting is from 700 mg/L to 1100 mg/L.

In some embodiments, a total organic carbon removal efficiency after 15 to 17 days of contacting the microalgae feedstock with the solution is from 83 to 87 percent based on an initial weight of the one or more organic compounds in the solution.

In some embodiments, a mass ratio of carbon to nitrogen to phosphorous (C:N:P) of 1-10:0.65-0.95:0.75-1.25.

In some embodiments, the method further comprises flowing the solution through a treatment pool having a conical end and a rectangular end. The solution enters the treatment pool through an apex of the conical end. At least a portion of the conical end at the apex has a transparent cover. The treatment pool comprises one or more transparent sheets disposed at different depths of the conical end of the treatment pool. The microalgae feedstock is attached to the one or more transparent sheets.

In some embodiments, an average removal of phosphorous after 15 to 17 days of contacting is 95 to 99 percent of an initial amount of nitrogen in the solution.

In some embodiments, an initial pH of the solution is from 5.2 to 5.4.

In some embodiments, an initial lipid content of the solution is from 0.5% to 1.5% based on a dry weight of biomass.

In some embodiments, a total lipid count of the solution after 15 to 17 days of contacting the microalgae feedstock with the solution is from 13% to 16% based on a dry weight of biomass. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a flowchart illustrating a method for removing organic compounds from a solution, according to certain embodiments.

FIG. 1B is a schematic drawing of a modified protocol for preparing acetate-based synthetic produced water (SPW), according to certain embodiments.

FIG. 2A is a schematic drawing of a lipid detection principle in the sulpho-phospho-vanillin (SPV) based colorimetric assay, according to certain embodiments.

FIG. 2B depicts a calibration curve of canola oil for lipid quantification, according to certain embodiments.

FIG. 3 is a graph depicting time profiles of optical densities at a wavelength of 680 nm (OD₆₈₀) as a growth feasibility of Chlorella sorokiniana in different produced water (PW) loadings, according to certain embodiments.

FIG. 4 is a graph depicting maximum biomass yields achieved from the cultivation of Chlorella sorokiniana under different PW loadings, according to certain embodiments.

FIG. 5A is a graph depicting total organic carbon (TOC) content in culture medium of different PW loadings on day 0, day 8, and day 16, according to certain embodiments.

FIG. 5B is a graph depicting maximum TOC removal efficiency on day 8, according to certain embodiments.

FIG. 6 is a graph depicting total nitrogen (TN) content remaining in the culture medium of different PW loadings on day 0, day 8, and day 16, according to certain embodiments.

FIG. 7 is a graph depicting total phosphorus (TP) content remaining in the culture medium of different PW loadings on day 0, day 8, and day 16, according to certain embodiments.

FIG. 8 is a graph depicting pH profiles over time during the cultivation of Chlorella sorokiniana of different PW loadings, according to certain embodiments.

FIG. 9 is a graph depicting total lipid content as a percentage of the dry weight of biomass of different PW loadings on day 0, day 8, and day 16 of the cultivation period, according to certain embodiments.

### DETAILED DESCRIPTION

In the following description, it is understood that other embodiments may be utilized, and structural and operational changes may be made without departure from the scope of the present embodiments disclosed herein.

When describing the present disclosure, the terms used are to be construed in accordance with the following definitions, unless a context dictates otherwise. Embodiments of the present disclosure will now be described more fully hereinafter with reference to the accompanying drawings wherever applicable, in which some, but not all embodiments of the disclosure are shown. In the drawings, reference numerals designate identical or corresponding parts throughout the several views. Further, as used herein, the words “a,” “an,” and the like generally carry a meaning of “one or more,” unless stated otherwise. Within the description of this disclosure, where a numerical limit or range is stated, the endpoints are included unless stated otherwise. Also, all values and subranges within a numerical limit or range are specifically included as if explicitly written out.

Furthermore, the terms “approximately,” “approximate,” “about” and similar terms generally refer to ranges that include the identified value within a margin of 20%, 10%, or preferably 5%, and any values therebetween.

As used herein, the term “hydrocarbon(s)” refers to the organic compounds made up of hydrogen and carbon atoms. Hydrocarbons include alkanes, also known as paraffins, alkenes, also called olefins, alkynes, and aromatic structures. Alkanes are saturated hydrocarbons with single bonds between carbon atoms. They form the backbone of many fossil fuels, such as methane (CH₄), ethane (C₂H₆), propane (C₃H₈), butane (C₄H₁₀), and the like. Alkenes are unsaturated hydrocarbons containing at least one carbon-carbon double bond. Examples of alkenes include ethylene (C₂H₄) and propylene (C₃H₆). Alkynes are unsaturated hydrocarbons with at least one carbon-carbon triple bond. Examples of alkynes include ethyne (C₂H₂) and 1-butyne (C₄H₆). Aromatic structures of hydrocarbons contain benzene rings or similar structures. Benzene (C₆H₆), toluene (C₇H₈), and xylene (C₈H₁₀) are common examples of aromatic hydrocarbons.

A weight percent (wt. %) of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

The present disclosure is intended to include all isotopes of a given compound or formula, unless otherwise noted. The present disclosure is intended to include all hydration states of a given compound or formula, unless otherwise noted or when heating a material.

Aspects of the present disclosure are directed to removing organic compounds in a solution using freshwater microalgae, Chlorella sorokiniana, as a halotolerant microalgae for the remediation of organic compounds in produced water (PW). Efficacy of the Chlorella sorokiniana strain in the removal of organic contaminants and nutrients from PW was evaluated for various parameters, including biomass growth, lipid content, and the ability of microalgae to metabolize organic compounds over time. The use of Chlorella sorokiniana holds promise for the remediation of organic compounds in PW, offering an environmentally friendly and sustainable solution to mitigate the environmental impact of petroleum-derived PW.

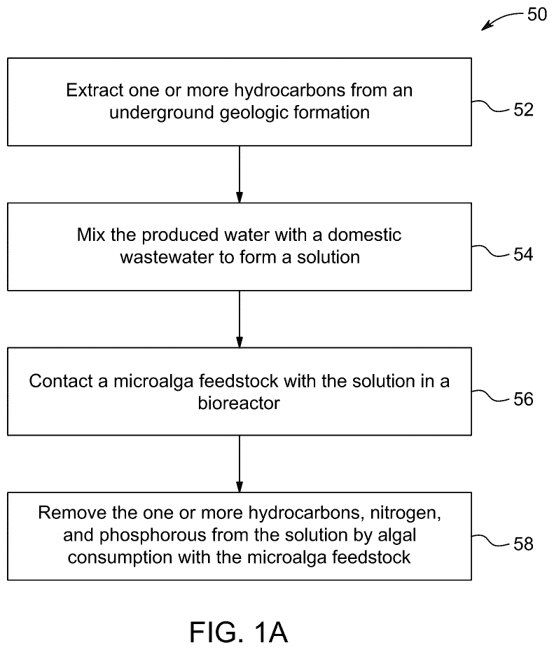

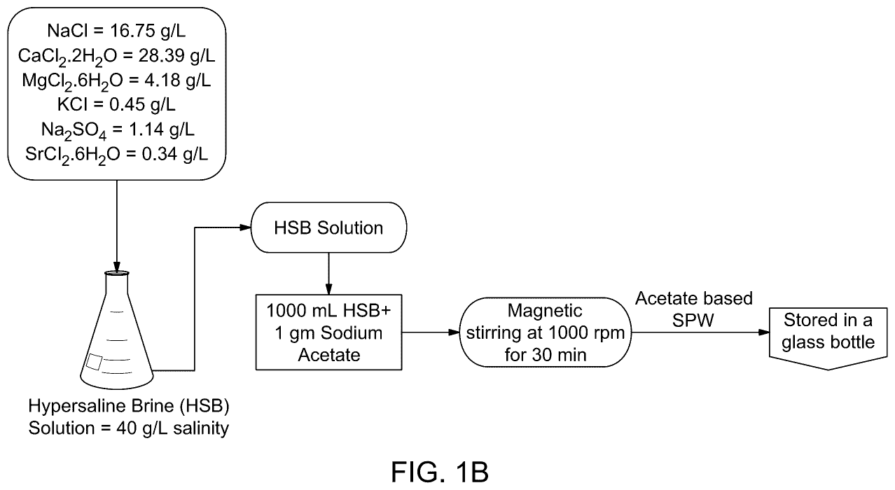

FIG. 1A illustrates a flow chart of a method 50 for organic compound removal from a solution. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes extracting one or more hydrocarbons from an underground geologic formation. In some embodiments, the hydrocarbons may be prepared in situ. As used herein, the term “underground geologic formation” encompasses a vast array of structures beneath the Earth's surface, shaped by geological processes over millions of years. The underground geologic formation may include, but is not limited to, caves and caverns, aquifers, oil and gas reservoirs, faults and folds, salt domes, volcanic chambers, sinkholes, karst landscapes, subterranean rivers, and the like. The one or more hydrocarbons may be extracted by any of the methods conventionally known in the art.

Extracting the one or more hydrocarbons from the underground geologic formation yields a hydrocarbon composition and a produced water. The hydrocarbon composition extracted from the underground geologic formation may include various hydrocarbons selected from natural gas, coal, crude oil, petroleum, combinations thereof, and the like.

As used herein, the term “produced water” is a water that comes out of the underground geologic formation (such as a well) with the crude oil, gas or hydrocarbon mixture during hydrocarbon production and/or during the extraction process. Produced water contains one or more hydrocarbons, such as soluble and/or non-soluble oil/organics, suspended solids, dissolved solids, and various chemicals used in the production process. In a specific embodiment, the produced water includes acetate. The produced water may further include one or more salts. The salts may be one or more of a sodium salt, a calcium salt, a magnesium salt, a potassium salt, a sulfate, and a strontium salt. The sodium salt may include, but is not limited to, sodium chloride, sodium bicarbonate, sodium carbonate, sodium hydroxide, sodium nitrate, sodium sulfate, a combination thereof, and the like. In a preferred embodiment, the sodium salt is sodium chloride. The calcium salt may include, but is not limited to, calcium carbonate, calcium chloride, calcium phosphate, calcium sulfate, calcium lactate, a combination thereof, and the like. In a preferred embodiment, the calcium salt is calcium chloride. The magnesium salt may include, but is not limited to, magnesium sulfate, magnesium chloride, magnesium oxide, magnesium citrate, magnesium hydroxide, a combination thereof, and the like. In a preferred embodiment, the magnesium salt is magnesium chloride. The potassium salt may include, but is not limited to, potassium chloride, potassium nitrate, potassium carbonate, potassium hydroxide, potassium citrate, potassium acetate, a combination thereof, and the like. In a preferred embodiment, the potassium salt is potassium chloride. The sulfate salt may include, but is not limited to, magnesium sulfate, sodium sulfate, calcium sulfate, potassium sulfate, barium sulfate, a combination thereof, and the like. In a preferred embodiment, the sulfate salt is sodium sulfate. The strontium salt may include, but is not limited to, strontium carbonate, strontium nitrate, strontium chloride, strontium sulfate, strontium hydroxide, a combination thereof, and the like. In a preferred embodiment, the strontium salt is strontium chloride.

In some embodiments, the produced water has a total dissolved solids value of 25,000 milligrams per liter (mg/L) to 25,500 mg/L, preferably 25,100 to 25,400 mg/L, more preferably 25,200 to 25,300 mg/L, and yet more preferably about 25,250 mg/L. In some embodiments, the produced water has a salinity of from 15,000 mg/L to 30,000 mg/L, preferably 10,000 mg/L to 50,000 mg/L, preferably 39,200 mg/L to 39,600 mg/L, preferably 39,300 to 39,500 mg/L, more preferably 39,400 to 39,450 mg/L, and yet more preferably about 39,410 mg/L. In some embodiments, the produced water has an electrical conductivity of 50 milli siemens per centimeter (mS/cm) to 70 mS/cm, preferably 55 to 65 mS/cm, more preferably 57 to 60 mS/cm, and yet more preferably about 58.90 mS/cm. In some embodiments, the produced water has a total organic carbon value of 330 mg/L to 350 mg/L, preferably 332 to 345 mg/L, more preferably 335 to 340 mg/L, and yet more preferably about 338.9 mg/L.

At step 54, the method 50 includes mixing the produced water with a domestic wastewater to form a solution. Sources of the domestic water may include, but are not limited to, residential sources such as toilets, bathing and showering, laundry, kitchen activities, sinks and drains; commercial sources such as restaurants, hotels, shopping malls, office buildings; institutional sources such as schools, hospitals, prisons, universities; recreational sources such as swimming pools, gyms, and sports facilities; miscellaneous sources such as car washing and yard maintenance, and the like. The domestic wastewater includes nitrogen and phosphorous. In some embodiments, the produced water is mixed with the domestic water at a volume ratio of 5:95 to 55:45, preferably 10:90 to 50:50, preferably 20:80 to 40:60 based on the total volume of the solution. In some embodiments, the solution has an initial pH in the range of 5.2 to 5.4, preferably 5.22 to 5.36, and more preferably about 5.25 to 5.34. The produced water serves as a hydrocarbon source, while the domestic water serves as a source of nitrogen and phosphorus for biological treatment. In some embodiments, a mass ratio of carbon to nitrogen to phosphorous in the solution (C:N:P) is about 1-10:0.65-0.95:0.75-1.25, preferably 2-8:0.7-0.9:0.8-1.2, preferably 4-6:0.74-0.85:0.9-1.1, more preferably about 1.15:0.7:1, about 3.1:0.9:1, about 4.48:0.89:1, about 5.96:0.75:1, and about 7.65:0.72:1.

At step 56, the method 50 includes contacting a microalgae feedstock with the solution in a bioreactor. The microalgae feedstock is Chlorella sorokiniana, also called a biomass. In some embodiments, the microalgae feedstock is preadapted. During preadapting of the biomass, the Chlorella sorokiniana may have been exposed to environmental conditions identical or similar to the conditions the Chlorella sorokiniana may be exposed to during the contacting. In some embodiments, the chemical structure of the biomass may be altered to ease oxidation reactions. The step of contacting the microalgae feedstock occurs in situ; however, one skilled in the art may recognize that the microalgae feedstock may be isolated from the specific site and subsequently reapplied at a target site, such as an underground geologic formation as frozen, dried, or freeze-dried cultures. In an embodiment, the preadapted microalgae feedstock is grown, replicating, and surviving in a mixture of synthetic produced water and synthetic domestic water identical to the mixture of synthetic produced water and synthetic domestic water used in the method 50. In other embodiments, the preadapted microalgae feedstock is grown, replicating, and surviving in a mixture of synthetic produced water and synthetic domestic water similar to the mixture of synthetic produced water and synthetic domestic water used in the method 50.

The concentration of the microalgae feedstock plays a role in biological treatment. In a preferred embodiment, the total lipid content of the microalgae feedstock after 15 to 17 days, more preferably 16 days of contacting is 10% to 17%, preferably 12 to 16%, and more preferably between 12.42% and 15.41%, based on a dry weight of biomass. In some embodiments, a maximal optical density of the Chlorella sorokiniana at a wavelength of 680 nanometers (nm) is from 3.2 to 5.2, preferably 3.5 to 5, more preferably 4 to 4.5, and yet more preferably about 4.2. In some embodiments, a maximum specific growth rate of the Chlorella sorokiniana is from about 0.1 per day (day-1) to 0.3 day-1, preferably 0.12 to 0.25 day-1, more preferably 0.14 to 0.2 day-1, and yet more preferably about 0.15 day-1. In some embodiments, a maximum biomass productivity of the Chlorella sorokiniana is from 45 mg/L to 55 mg/L per day, preferably 40.8 mg/L/d, 48.2 mg/L/d, 50.8 mg/L/d, 48.2 mg/L/d, and 48.4 mg/L/d.

The microalgae feedstock may be in contact with the solution in the bioreactor for any length of time to remove and/or biodegrade the organic pollutants and/or hydrocarbons in the produced water. Preferably, the microalgae feedstock is in contact with the solution for about 1 day to 20 days, preferably 7 to 19 days, more preferably 14 to 18 days, and yet more preferably about 16 days.

The microalgae feedstock may be in contact with the solution at any temperature which allows for biodegradation of the organic pollutants and/or hydrocarbons in the produced water. Preferably the microalgae feedstock may be in contact with the solution at a temperature of from 10 to 45° C., preferably 15 to 40° C., preferably 20 to 35° C., and preferably 25 to 30° C.

The microalgae feedstock may be in contact with the solution at any pH that allow for biodegradation of the organic pollutants and/or hydrocarbons in the produced water. Preferably the microalgae feedstock may be in contact with the solution at a pH of 4 to 8, preferably 5 to 7, more preferably 5 to 6, more preferably 5.2 to 5.4, and yet more preferably about 5.25 to 5.34.

In some embodiments, a biomass output of the Chlorella sorokiniana after 15 to 17 days, more preferably 16 days, of contacting the microalgae feedstock with the solution is from 700 mg/L to 1100 mg/L, preferably 800 to 1000 mg/L, and preferably 850 to 950 mg/L. In a preferred embodiment, a biomass output of the Chlorella sorokiniana after 16 days of contacting the microalgae feedstock with the solution is from preferably 733 mg/L to 1077 mg/L. In some embodiments, the initial lipid content of the solution is from 0.5% to 1.5% based on a dry weight of biomass. In some embodiments, a total lipid counts of the solution after 15 to 17, more preferably 16 days of contacting is from 13% to 16%, preferably 14 to 15%, based on a dry weight of biomass.

At step 58, the method 50 includes removing the one or more hydrocarbons, nitrogen, and phosphorous from the solution by algal consumption with the microalgae feedstock. To elaborate, the microalgae feedstock feeds on the hydrocarbons (from the produced water), nitrogen and phosphorus (from the domestic water) in the solution, in the bioreactor, resulting in algal growth, and subsequent removal of the hydrocarbons, nitrogen, and phosphorous from the solution.

In some embodiments, the method of the present disclosure results in removal of the one or more hydrocarbons in an amount of 80 percent by weight (wt. %) to 90 wt. %, preferably 81 to 89 wt. %, more preferably 82 to 88 wt. %, more preferably 83 to 87 wt. %, more preferably 84 to 85 wt. %, and yet more preferably about 84.92 wt. %, based on the total weight of the one or more hydrocarbons in the solution. In some embodiments, the method of the present disclosure results in removal of nitrogen in an amount of 70 to 95 wt. %, preferably 75 wt. % to 90 wt. %, preferably 77 to 88 wt. %, preferably 80 to 85 wt. %, based on the total weight of the nitrogen in the solution, and phosphorous is removed in an amount of 90 wt. % to 100 wt. %, preferably 91 to 99 wt. %, preferably 92 to 98 wt. %, preferably 93 to 97 wt. %, based on the total weight of the phosphorus in the solution. In a preferred embodiment, the total organic carbon removal efficiency after 15 to 17 days of contacting the microalgae feedstock with the solution in the bioreactor is from 83 to 87 percent, more preferably 84 to 85 percent, and yet more preferably about 84.92 percent based on an initial weight of the one or more organic compounds in the solution. In some embodiments, the average removal of nitrogen after 15 to 17 days of contacting the microalgae feedstock with the solution in the bioreactor is 75 to 88 percent, preferably 76 to 87 percent, of an initial amount of nitrogen in the solution. In some embodiments, the average removal of phosphorous after 15 to 17 days of contacting the microalgae feedstock with the solution in the bioreactor is 95 to 99 percent, preferably 96 to 98 percent, of an initial amount of nitrogen in the solution.

In a preferable embodiment, the produced water and domestic water are combined to form a single fluid stream upstream of a treatment pool. Mixing the produced water and domestic water forms a homogeneous solution optionally with suspended solids. The homogeneous solution is flowed to a treatment pool having a conical end and a rectangular end. The homogeneous solution is flowed into a top of an apex of the conical end of the treatment pool. The treatment pool is preferably outside and completely exposed to sunlight (not shaded). The conical portion of the treatment pool is more shallow at the apex end than at the end which joins the rectangular portion of the treatment pool. The bottom of the treatment pool slopes downward from the apex end to meet the bottom of the treatment pool at the join between conical and rectangular portions of the treatment pool. The slope is preferably at a pitch of 1:3, 1:4, or 1:5.

Preferably at least a portion of the conical portion, beginning at the apex and extending a distance of 20-80%, 30-70% or 40-60% of the total length of the conical portion, is covered with or contains transparent polymer sheets at the surface, over the surface, or at different depths in the treatment pool. As the homogenous solution enters at the apex of the treatment pool, it passes along the upper and lower surfaces of any transparent polymer sheets that are in the treatment pool. Transparent sheets are preferably present at depths within the homogeneous fluid and preferably have surfaces that include a series of ridges and valleys represented as protrusions having a height of 1-10 mm, 2-8 mm, or 4-6 mm from the surface of the transparent sheet. The structures are preferably collinear with the direction of flow of water from the apex end to the rectangular end of the treatment pool. The transparent sheets may be rigid or flexible. A treatment pool containing ridged, transparent polymer sheets provides a substrate for microorganism (Chlorella sorokiniana in the current disclosure) attachment and intimate contact with the homogeneous solution that is transferred into the treatment pool. In some embodiments, the transparent sheets may have a textured surface for microorganism attachment. The textured surface may have bumps, waves, pores, protrusions, indents, and may be any texture known in the art. The transparent sheets are preferably transparent, e.g., a light transmission of at least 50%, at least 70% or at least 85% in the visible region of the spectrum. Transparency and surface area provide a desirable growth substrate for the biological treatment agent. As the treatment solution is flowed under and between the transparent polymer sheets, bacteria present on these sheet substrates begin the degradation process of hydrocarbon materials in the treatment solution. The bacteria do not remain fully immobile on the substrate but are instead often carried away by the flow of the treatment solution into the rectangular portion of the treatment pool. In this manner, the bacteria are able to quickly and efficiently act on the produced water and provide a ready supply of bacteria for downstream wastewater treatment.

### EXAMPLES

The following examples describe and demonstrate a method of removing organic compounds from a solution using halotolerant microalgae, Chlorella sorokiniana. The examples are provided solely for illustration and are not to be construed as limitations of the present disclosure, as many variations thereof are possible without departing from the spirit and scope of the present disclosure.

### Example 1: Microalgae Strains

All the experiments pertaining to the present disclosure were carried out using the freshwater microalgae species Chlorella sorokiniana (UTEX 1230), obtained from the University of Texas at Austin, USA.

### Example 2: Preparation and Characterization of Synthetic Produced Water

The preparation and characterization of synthetic petroleum-derived produced water constitute many aspects of environmental research and engineering initiatives. Synthetic-produced water (SPW) is engineered within a controlled laboratory environment to closely emulate the composition and characteristics of actual PW generated during petroleum extraction processes. The creation of SPW entails a detailed analysis of the composition of genuine PW derived from specific gas or oil reservoirs. The types and concentrations of organic pollutants, HMs, salts, and other contaminants are identified and commonly encountered in real PW. The SPW is formulated by blending chemical reagents, salts, and contaminants to mirror real PW. The selection of reagents and associated concentration aligns with the characteristics of real PW. A modified, hypersaline SPW was utilized as the basis of real PW. Further, acetate was used as the dissolved carbon source to create an organic load in the hypersaline medium to obtain the acetate based SPW utilized in the present disclosure. FIG. 1B depicts the modified protocol for preparing acetate based SPW.

The pH of the samples were determined using a pH meter (OAKTON, pH 700), while the salinity, total dissolved solids (TDS), and electrical conductivity (EC) were measured using a conductivity meter (Fisher brand, Accumet AB330). Total organic carbon (TOC) was analyzed using a TOC analyzer (TOC-VCSN, SHIMADZU, Japan). The components of petroleum derived SPW are listed in Table 1.

TABLE 1
Components of petroleum derived SPW

| Parameter | Values |
|---|---|
| TDS (Total dissolved solids) (mg/L) | 25250 |
| Salinity (mg/L) | 39410 |
| EC (Electrical conductivity) (mS/cm) | 58.90 |
| TOC (Total organic carbon) (mg/L) | 338.9 |
| pH | 6.54 |

### Example 3: Chlorella sorokiniana Inoculum

The microalgae strain Chlorella sorokiniana (UTEX 1230) was transferred to a 500 mL conical flask with 200 mL of UTEX-prescribed protease medium for first-stage culture. The microalgal cells were incubated under continuous, white, fluorescent light illumination at 1800-1900 lux, maintaining 22±1° C. temperature without any aeration. Once the microalgae culture reached enough concentration, at least optical density (OD₆₈₀) of 4.2, 50 mL of microalgae sample was again transferred to a 1 L conical flask consisting of 800 mL medium of a mixture of 20% hypersaline brine (HSB) solution, as shown in FIG. 1B, and 80% synthetic domestic wastewater (SDW) by volume and incubated under aeration for a second-stage cultivation. Further, 50 mL of a microalgae sample from the end of the growth phase of the second stage cultivation (after 10 days) was collected and utilized as an inoculum to conduct the bioremediation experiment in different gradients of SPW. The compositions of proteose medium and SDW medium are recorded in Table 2 and Table 3, respectively.

TABLE 2
Compositions of protease media

| Constituent | Final concentration | |
|---|---|---|
| NaNO₃ | 250 | mg/L |
| CaCl₂•2H₂O | 25 | mg/L |
| MgSO₄•7H₂O | 75 | mg/L |
| K₂HPO₄ | 75 | mg/L |
| KH₂PO₄ | 176 | mg/L |
| NaCl | 25 | mg/L |
| Proteose Peptone | 1 | g/L |

TABLE 3
Compositions of synthetic domestic wastewater
(SDW) used for supplementation.

| Constituent | Final concentration | |
|---|---|---|
| NaNO₃ | 250 | mg/L |
| CaCl₂•2H₂O | 25 | mg/L |
| MgSO₄•7H₂O | 75 | mg/L |
| K₂HPO₄ | 75 | mg/L |
| KH₂PO₄ | 176 | mg/L |
| NaCl | 25 | mg/L |
| Alkaline EDTA | 50 | mg/L |
| FeSO₄•7H₂O (acidified) | 4.98 | mg/L |
| H₃BO₃ | 11.45 | mg/L |
| Trace elements solution | 1 | mL/L |

Composition of trace elements
solution in one liter dH₂O (separately):

| | | |
|---|---|---|
| CoCl₂•6H₂O | 0.49 | gm |
| ZnSO₄•7H₂O | 8.82 | gm |
| MnCl₂•4H₂O | 1.44 | gm |
| MoO₃ | 0.71 | gm |
| CuSO₄•5H₂O | 1.57 | gm |

### Example 4: Experimental Setup

To assess how effectively microalgae removes dissolved organic pollutants from acetate based SPW, Chlorella sorokiniana inoculum was cultivated in seven experimental media formulations. A series of photobioreactors were used, each containing a different concentration of SPW. The photobioreactors were supplemented with SDW to create seven different concentration gradients, including 0%, 10%, 20%, 30%, 40%, 50%, and 100% PW. The photobioreactor containing 0% of PW, includes SDW medium and microalgae strains. Borosilicate glass Erlenmeyer flasks were utilized as batch photobioreactors. The flasks or photobioreactors were filled with a total volume of 850 mL of the working liquid medium, including inoculum and 800 mL of supplemented SPW. At the start of the experimental trial, the photobioreactors were filled with 50 mL of prepared inoculum for an initial optical density (OD₆₈₀) within the range of 0.375 to 0.4, allowing for accurate comparison. Before the operation, the SPW media in all photobioreactors were supplemented and adjusted to an initial pH value of 6.8 by adding 1 N NaOH. The media were then sterilized by autoclaving at a temperature of 120° C. for 15 minutes. The photobioreactors were tightly sealed using foam stoppers to protect the contents from contamination. Under a fume hood, a large percentage of the surface area of the photobioreactors was covered by four fluorescent tubes that were horizontally altered, uninterrupted, and white in color. The light intensity at the surface of the reactor was measured to be in the range of 1800 lux to 1900 lux using a Fisher Scientific Traceable dual-display light meter. The tests were conducted for 16 days under ambient conditions, namely at 22±1° C.

The air-CO₂ mixing system FC-SH (Live Cell Instruments, South Korea) was used to aerate the hydrodynamics of the system. The air flow rate was controlled by a glass rotameter on the mixing device and maintained at 1500 cubic centimeters per minute (cc/min) as needed. Gas bubbles were generated inside the liquid cultivation medium and released through the upper part of the reactor, thereby avoiding the settling of the cells. To prevent the settling of microalgae, the photobioreactor was agitated manually three times a day. Chlorella sorokiniana was grown in a mixotrophic environment, where the culture medium was supplied with inorganic (atmospheric air) and organic (produced water) carbon. The elimination of the organic pollutant was monitored at seven-day time intervals, including day 0, day 8, and day 16.

### Example 5: Microalgal Growth and Biomass Determination

Before sampling for algal growth determination, sterile water was added to each photobioreactor to adjust the volume loss of the cultivation medium due to evaporation. 15 mL samples were collected every alternative day to measure the optical density (OD), dry biomass concentration, and pH of the culture medium. The absorbance of microalgae samples was measured at a wavelength of 680 nm in comparison to a blank sample to determine the optical density (OD) of the medium used for the culture of microalgae using an ultraviolet-visible (UV-vis) spectrophotometer (Evolution 260 Bio-Thermo Scientific). The necessary dilution of the culture medium was maintained to accurately measure the OD when the OD was greater than one. To determine the dry cell (biomass) content of microalgae, 14 mL portions of the culture medium were centrifuged and washed with distilled water twice to remove the surface salts from the biomass. After that, biomass was vacuum filtered using pre-dried and pre-weighed glass microfiber filter paper (Whatman GF/C) with a 0.45 micrometer (μm) pore size and 0.47 millimeter (mm) diameter. The filter paper with the biomass was subjected to 24 hours of drying in an oven at 60° C. before reweighing. The difference in weight before and after drying was utilized to compute the microalgae dry cell content. This measured dry weight was the basis for determining the biomass concentration in milligrams per liter (mg/L).

### Example 6: Specific Growth Rate

The specific growth rate, denoted as μ_{g}, was determined using the following equation:

$$Specific growth rate , {μ}_{g} = \frac{ln ( \frac{{OD}_{t}}{{OD}_{0}} )}{t - {t}_{0}}$$

where, ODₜ and ODₒ are the optical densities measured at the final (t) and initial (tₒ) duration of the exponential growth phase, respectively. Specific growth rate represents the rate at which the dry biomass weight increases per day.

### Example 7: Biomass Productivity

The biomass productivity, often referred to as the biomass production rate, is determined using the following equation:

$$Biomass productivity , {P}_{b} = \frac{{X}_{t} - {X}_{0}}{{t}_{t} - {t}_{0}}$$

where X₀ represents the initial dry biomass weight measured at the start of the cultivation or growth phase, which occurs at time t₀, and Xₜ is the dry biomass weight at the end of the cultivation phase, which is observed at time tₜ.

### Example 8: Nutrient Removal Analysis

To assess the nutrient removal, 10 mL microalgae culture samples were collected from the photobioreactors. The collected samples underwent centrifugation at 4500 rpm for 10 minutes. This process separated the supernatants, which were preserved for subsequent analysis. Nitrogen and phosphorous amounts were determined with a spectrophotometer (DR 3900-HACH, USA) and a digital reactor (DRB 200-HACH, USA). The presence of total nitrogen (TN) in the form of N—NO₃⁻ and total phosphorus (TP) in the form of PO₄³⁻ in the culture medium was quantified. The percentages of TN and TP removal rates were calculated based on batch kinetics. Th calculation was carried out using the provided equation:

$$\% removal = \frac{{S}_{0} - {S}_{t}}{{S}_{0}} \times 100$$

where S₀ and Sₜ represent the substrate concentration at two specific points in time. S₀ is the concentration at the beginning of the cultivation, corresponding to time to, while Sₜ is the concentration at the end of the cultivation recorded at time tₜ.

### Example 9: TOC Removal Analysis

20 mL samples from each photobioreactor were collected on days 0, 8, and 16. The collected samples were centrifuged at 4500 rpm for 10 minutes. This process separated the supernatants, which were preserved and utilized for TOC analysis using a TOC analyzer (TOC-VCSN, SHIMADZU, Japan).

### Example 10: Lipid Content in Microalgae Biomass

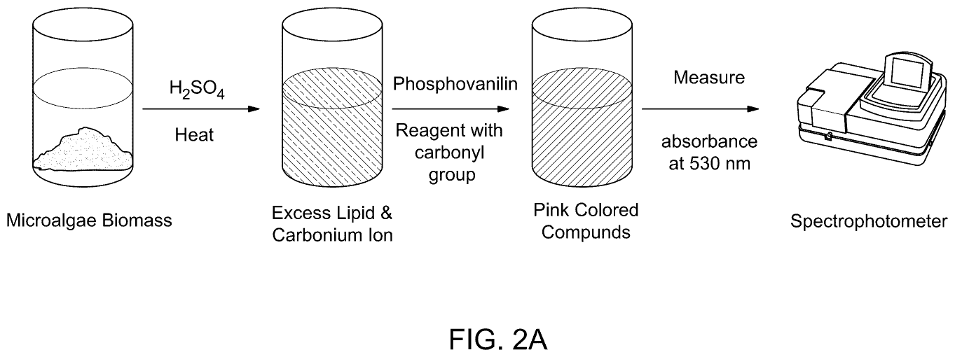

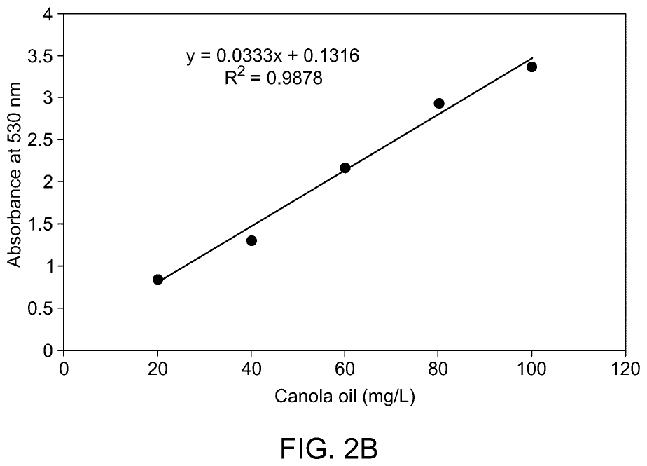

Sulfo-phospho-vanillin (SPV) technique was used to evaluate the lipid composition [Byreddy, A. R., Gupta, A., Barrow, C. J., and Puri, M., A quick colorimetric method for total lipid quantification in microalgae, J. Microbiol. Methods, 2016, 125, 28-32, which is incorporated herein by reference in its entirety]. The lipid finding mechanism in the SPV-based colorimetric assay is shown in FIG. 2A. Canola oil was used to create a calibration curve following the steps outlined in the SPV method. Five-milliliter microalgae samples were taken from the photobioreactor for several days to ascertain the intracellular lipid substance. After centrifuging the samples for 10 minutes at 4500 rpm to remove any salts from the cell surface, they were diluted and washed three times with distilled water. The biomass was exposed to one milliliter of 98% sulfuric acid before being heated to 100° C. for ten minutes. The sample was cooled in an ice bath for five minutes before being treated with five milliliters of SPV reagent. The samples were then shaken at 200 rpm for 15 minutes at 37° C. in an incubator. After incubation, the absorbance of the samples was measured at 530 nm using a UV spectrophotometer. With an R² value of 0.9878 from the measured absorbance, the lipid content of the samples was calculated using the equation y_{OD530}=0.0333X_{lipid}+0.1316 (FIG. 2B). Then, using the equation below, the total amount of lipid was calculated as a percentage of the dry biomass weight.

$$Lipid content ( \% ) = \frac{{X}_{L}}{{X}_{B}} \times 100$$

where X_{B} represents the dry weight of the biomass in the sample, and XL represents the amount of lipid present in the sample.

### Example 11: Statistical Analysis

The analysis was performed using the mean of the data from all three replicate sets of experiments. The means and standard deviations (+SD) were utilized to calculate the standard deviation (SD) of repeated experimental data. A one-way analysis of variance (ANOVA) was performed to evaluate the degree of variation among the different treatment groups. Statistical significance was attributed to a difference when p<0.05.

### Example 12: Microalgal Growth and Biomass Concentration

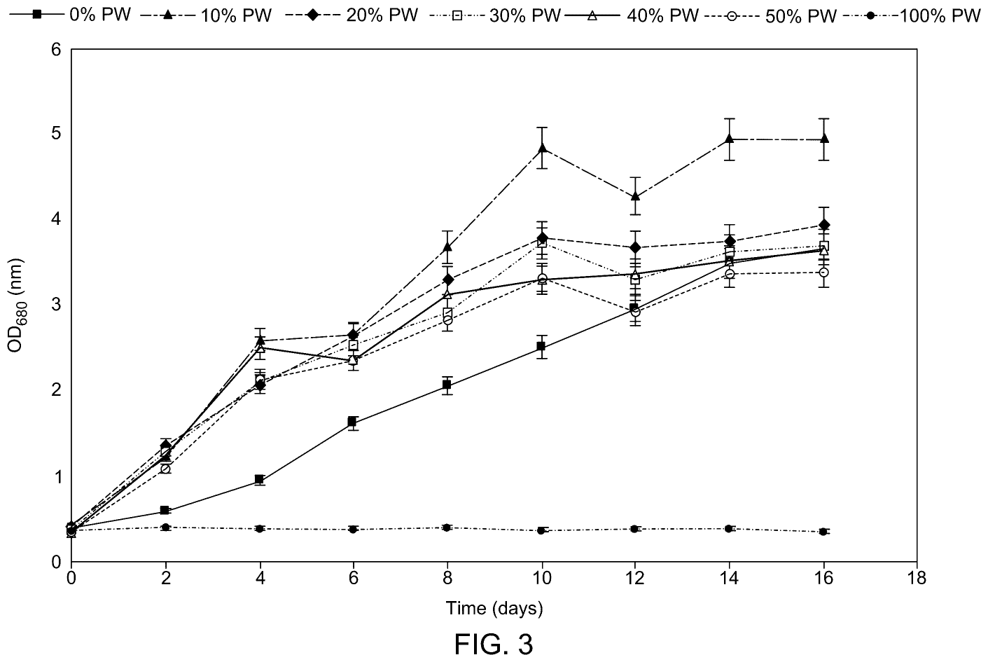

Preadapted microalgae Chlorella sorokiniana inoculum was cultivated in SPW supplemented with SDW to evaluate the growth parameters and bioremediation capacity. FIG. 3 demonstrates the time profiles of optical densities (OD₆₈₀) as a growth feasibility of Chlorella sorokiniana in different PW loadings. As can be seen in FIG. 3, microalgae successfully adapted at PW loadings of 0% (control), 10%, 20%, 30%, 40%, and 50%; however, microalgae did not grow well in 100% PW due to the lack of appropriate nutrients and high salinity. Due to the utilization of preadapted microalgae cells, the lag phase was avoided in the culture of all photobioreactors except 100% PW. The common end of the exponential growth phase was observed on day 10 in all the photobioreactors having the culture media of 10%, 20%, 30%, 40%, and 50% PW loadings. Microalgae grew well for the 16-day cultivation period, maintaining higher OD values for all PW loadings higher than 0% PW (control). OD values of 100% PW were consistently lower than those of 0% PW (control) during the cultivation period.

As can be seen in FIG. 3, microalgae in 10% PW showed the highest OD values during the cultivation period compared to the medium composed of 20%, 30%, 40%, and 50% PW. This may be due to the increasing salinity with increasing PW loadings in the culture medium. A slight variation was recorded in the observed values of OD of microalgae cultures until day 6 among the 10%, 20%, 30%, 40%, and 50% PW loadings. Microalgae culture in 10% PW revealed higher OD values for the rest of the cultivation period than those of other PW loadings; however, from day 6 to day 16, a similar growth trend was observed among 20%, 30%, 40%, and 50% PW loadings. Higher OD values were shown in the order of lower PW loadings (20%, 30%, and 40%, respectively) after the end of the cultivation. According to the analysis of variance (ANOVA), the mean differences in OD values between the treatment groups (PW loadings) are statistically significant (p-value=0.000128<0.05).

Table 3 depicts the growth kinetics parameters, such as maximum specific growth rate (μₘₐₓ) and maximum biomass productivity (Pₘₐₓ), of Chlorella sorokiniana cultivated under the different PW loadings. As shown in Table 3, the average specific growth rates at PW loadings of 0%, 10%, 20%, 30%, 40%, and 50% were 0.15, 0.24, 0.22, 0.23, 0.15, and 0.22 per day (day⁻¹), respectively. As seen from the results, the highest specific growth rate was seen for 10% of PW loadings. In addition, the specific growth rate for other PW loadings is similar except for 0% PW and 40% PW loadings. The specific growth rate, 0.15 day-1, for 40% PW is relatively lower than other loadings, possibly due to the growth drop at the end of the exponential growth phase. A relatively lower specific growth rate was observed for 0% PW (control) due to the absence of a congruent amount of carbon in the culture medium compared to the supplemented PW. Table 3 shows the biomass productivity of microalgae culturing at different PW loadings. An average biomass productivity of 53.1 milligrams per liter per day (mg/L/d) was achieved for 10% PW loadings, which is higher than other loadings Average biomass productivity for 0% PW, 20% PW, 30% PW, 40% PW, and 50% PW was found to be 40.8 mg/L/d, 48.2 mg/L/d, 50.8 mg/L/d, 48.2 mg/L/d, and 48.4 mg/L/d, respectively. The obtained results of biomass productivity for different PW loadings are 1.3 to 1.2 times higher than that of 0% PW (control). The comparable growth kinetics parameters obtained for freshwater microalgae support that Chlorella sorokiniana cultivated under hypersaline PW supports its halotolerant capacity.

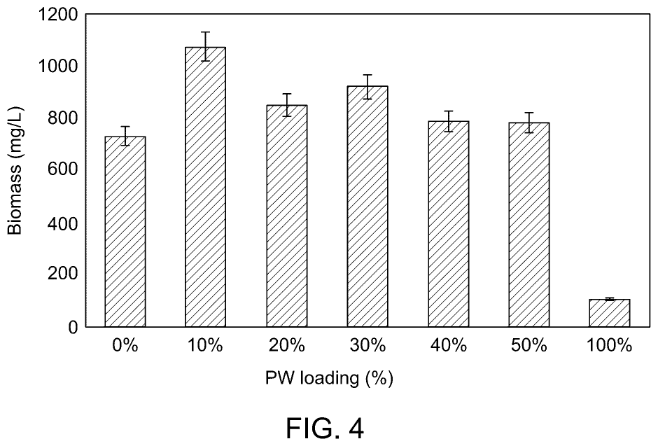

The maximum biomass yields obtained from Chlorella sorokiniana culture with varying PW loadings (0% to 100%) are shown in FIG. 4. Considering all PW loadings, the average maximal biomass output was found to vary from 733 mg/L to 1077 mg/L, except 100% PW, which was about 107 mg/L and indicated almost no microalgae development in that culture medium. Microalgae culture with 10% PW showed the highest biomass concentration (1077 mg/L), followed by 30% PW (924 mg/L), 20% PW (851 mg/L), 40% PW (788 mg/L), 50% PW (785 mg/L), and 0% PW (733 mg/L). The dry biomass concentration achieved for different PW loadings is higher than that of 0% PW (control). Biomass concentration decreased with increased salinity, translating to increasing PW loadings in the culture medium.

TABLE 3
Conditions and growth parameters of Chlorella sorokiniana
cultivated in supplemented SPW

| | | | Max. specific | | Max. Biomass |
|---|---|---|---|---|---|
| PW loading | Salinity | Maximal | growth rate, μₘ | Cultivation | productivity |
| (%) | (g/L) | OD₆₈₀ | (day⁻¹) | Period (day) | (mg/L/d) |
| 0 | 0.43 | 3.66 ± 0.07 | 0.15 ± 0.003 | 16 | 40.8 ± 0.80 |
| 10 | 6.80 | 4.95 ± 0.10 | 0.24 ± 0.007 | 16 | 53.1 ± 1.60 |
| 20 | 13.15 | 3.95 ± 0.07 | 0.22 ± 0.004 | 16 | 48.2 ± 0.96 |
| 30 | 19.79 | 3.71 ± 0.10 | 0.23 ± 0.006 | 16 | 50.8 ± 1.50 |
| 40 | 26.19 | 3.65 ± 0.07 | 0.15 ± 0.003 | 16 | 48.2 ± 0.96 |
| 50 | 32.61 | 3.39 ± 0.06 | 0.22 ± 0.004 | 16 | 48.4 ± 0.97 |
| 100 | 63.46 | 0.35 ± 0.007 | 0.013 ± 0.0003 | 16 | 0.0 |

### Example 13: Bioremediation of PW-TOC Removal

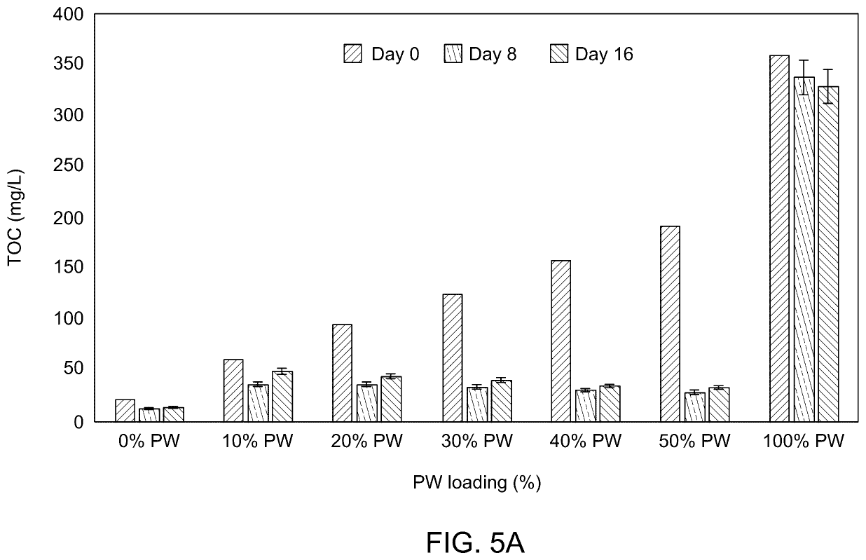

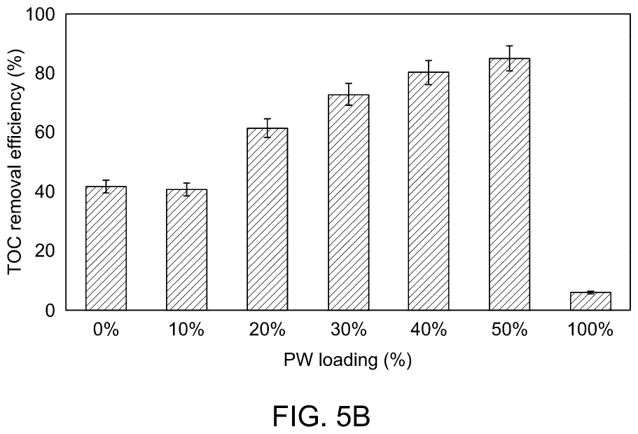

To assess the bioremediation efficiency of PW by microalgae, the TOC of the culture medium of different photobioreactors was monitored on days 0, 8, and 16. FIG. 5A illustrates the TOC content in different PW loadings on day 0, day 8, and day 16. According to FIG. 5A, higher PW loadings showed the incremental increase in an initial TOC value in the culture medium. The highest amount of carbon uptake by microalgae occurred on day 8, showing the lowest TOC value for all photobioreactors, except photobioreactors having 100% PW. In addition, as depicted in FIG. 5B, TOC removal efficiency increased gradually with increasing PW loadings, except 100% PW. The initial TOC value of 50% PW was 191.3 mg/L, and after bioremediation by microalgae, it reached around 28.84 mg/L on day 8, indicating the maximum average removal efficiency of about 84.92%. Maximum average TOC removal efficiency on day 8 for other PW loadings are 41.66%, 40.79%, 61.54%, 72.8%, and 80.38% for 0%, 10%, 20%, 30%, and 40%, respectively. The variation of TOC removal efficiency among the treatment groups is statistically significant (p-value=0.015904<0.05). According to FIG. 5A and FIG. 5B, higher TOC removal efficiency accounts for higher initial TOC value considering all PW loadings except 100% PW. The TOC removal efficiency for 100% PW was 6.05% (initial TOC=358.4 mg/L) on day 16. As 100% PW showed no growth, the minor percentage of TOC removal may be due to biodegradation. The findings demonstrate that the microalgae Chlorella sorokiniana may effectively decompose and utilize the organic compounds in the supplemented PW to support their growth. Moreover, as shown in FIG. 5A, TOC of culture medium in all photobioreactors except 100% PW was higher on day 16 than on day 8.

As shown in FIG. 5A, carbon uptake by microalgae is influenced by nutrient concentration in the culture medium. Reducing the levels of nitrogen (N) and phosphorus (P) while increasing the amount of carbon (C) in SPW-SDW media by increasing the PW loading results in enhanced carbon uptake by microalgae throughout the cultivation period; therefore, introducing higher PW effluent loadings into the growth medium may enhance the absorption of carbon by microalgae. The photobioreactors having the dilutions of 10%, 20%, 30%, 40%, and 50% of PW support that the initial average TOC values for each dilution were 61.48 mg/L, 94.71 mg/L, 124.7 mg/L, 157.5 mg/L, and 191.3 mg/L, respectively. As a result, carbon to nitrogen to phosphorus (C:N:P) mass ratios were found to be 1.15:0.7:1, 3.1:0.9:1, 4.48:0.89:1, 5.96:0.75:1, and 7.65:0.72:1 for 10%, 20%, 30%, 40%, and 50% of PW loadings, respectively. Considering C:N:P ratios for incremental PW loadings, it was seen that decreasing nitrogen and phosphorus concentrations by maintaining the almost constant N:P ratios and concurrently increasing organic carbon leads to maximum removal of TOC from the culture medium. Despite the imbalanced cultivation conditions regarding macronutrients, the halotolerant freshwater microalgae Chlorella sorokiniana demonstrated adaptation by incorporating supplemented SPW. Additionally, an efficiency of 84.92% for 50% PW in removing TOC was achieved. Overall, freshwater halotolerant microalgae Chlorella sorokiniana was shown to be a candidate to bioremediate supplemented PW under mixotrophic conditions.

Mixotrophy refers to the capacity of specific microalgae to utilize dissolved organic carbon as a source of carbon when light is available. The three major methods that microalgae may use to remove organics from wastewater are biodegradation, consumption, and biosorption. The polymer groups in the cell walls of microalgae may provide potential sorption sites for organic contaminants. The microalgae Chlorella sorokiniana were mixotrophic, and thus, TOC was eliminated from the PW owing to the combination of biosorption, consumption, and biodegradation. The microalgae cell wall has a plurality of binding sites and functional groups that aid in electrostatic contact, adsorption, surface precipitation, chelation, and ion exchange during biosorption. A percentage of TOC may be removed from the microalgae culture medium due to the consumption or bioaccumulation of organic components inside the cell during microalgal growth. Bioaccumulation is a procedure that depends on growth, and is metabolically active. During the process of total organic carbon (TOC) consumption, acetate is first converted into acetyl coenzyme A (acetyl-CoA) and is then incorporated into algal carbohydrates through the glyoxylate cycle, in collaboration with the tricarboxylic acid cycle (TCA cycle). The TOC removal efficiency for 100% PW was 6.05% (initial TOC=358.4 mg/L) on day 16. As 100% PW showed no growth, the minor percentage of TOC removal may be due to the biodegradation mechanism.

### Example 14: Nutrient Uptake

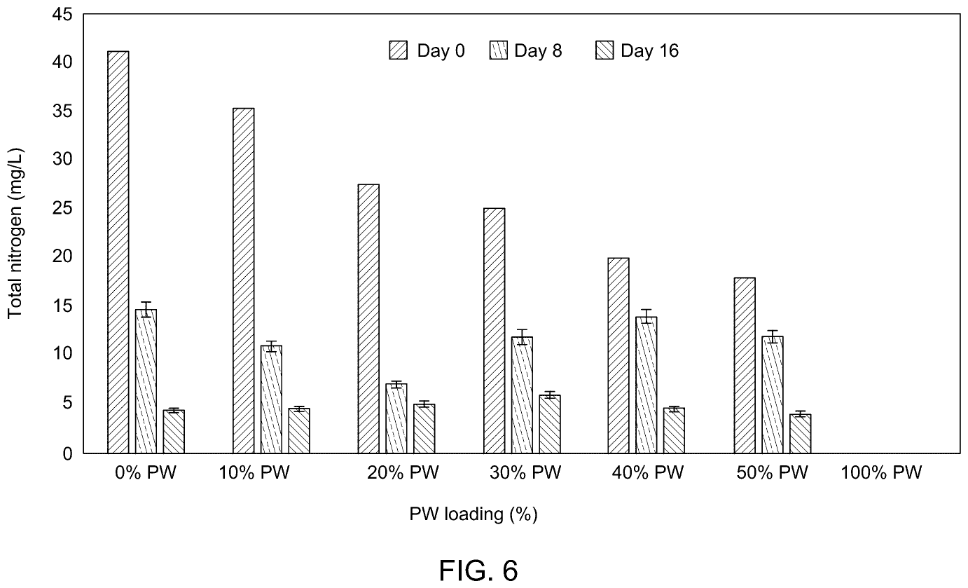

PW may exhibit a deficiency in nitrogen and phosphorus, which may bring the C/N ratio below an optimal range for fostering microalgal growth. SPW prepared in the present disclosure does not contain nitrogen or phosphorus, as shown in Table 1. Thus, PW was supplemented with SDW as a source of nutrients for microalgal growth. Due to the supplementation with SDW, the photobioreactor having the dilutions of 0%, 10%, 20%, 30%, 40%, and 50% of PW showed that the initial average nitrogen values for each dilution were 41.17 mg/L, 35.34 mg/L, 27.5 mg/L, 25 mg/L, 20 mg/L, and 18 mg/L, respectively. 100% PW contains no N and P concentration as it was not supplemented with SDW. To investigate the nutrient uptake capacity of Chlorella sorokiniana under a PW environment, two primary nutrients (nitrogen and phosphorus) were monitored at day 0, day 8, and day 16 during the cultivation period. FIG. 6 shows the total nitrogen (TN) content remaining in the culture medium of different PW loadings at days 0, 8, and 16 of the cultivation periods. As can be seen from FIG. 6, the initial nitrogen concentration decreased with an increase in PW loadings. Nitrogen concentration decreased gradually with increased microalgal growth across all PW loadings. On day 8 of the cultivation period, nitrogen concentration reached around 14.7 mg/L, 11.0 mg/L, 7.0 mg/L, 12 mg/L, 14 mg/L, and 12 mg/L in the photobioreactors having the PW loadings of 0%, 10%, 20%, 30%, 40%, and 50%, respectively. At the end of cultivation on day 16, average nitrogen removal by 10% PW loadings was 87.2%, which was slightly lower than 0% PW (89.3%) (control). The average nitrogen removal for other photobioreactors was 81.8%, 76%, 77.5%, and 77.8% for 20% PW, 30% PW, 40% PW, and 50% PW, respectively, and found no statistically significant difference (p-value=0.978467>0.05). Experimental evidence demonstrates that elevated salinity levels negatively impacted the ability of Chlorella sorokiniana to remove nutrients from PW, as indicated by reduced nitrogen removal. Moreover, the presence of major ion concentrations in PW solution may affect the nutrient removal mechanism by microalgae. Consequently, large amounts of these nutrients were depleted from the supplemented PW medium due to microalgae growth by the end of the culture period. Although the microalgae in the PW may not fully eliminate nitrogen, the residual nitrogen levels typically fall within the range of 4 mg/L to 6 mg/L.

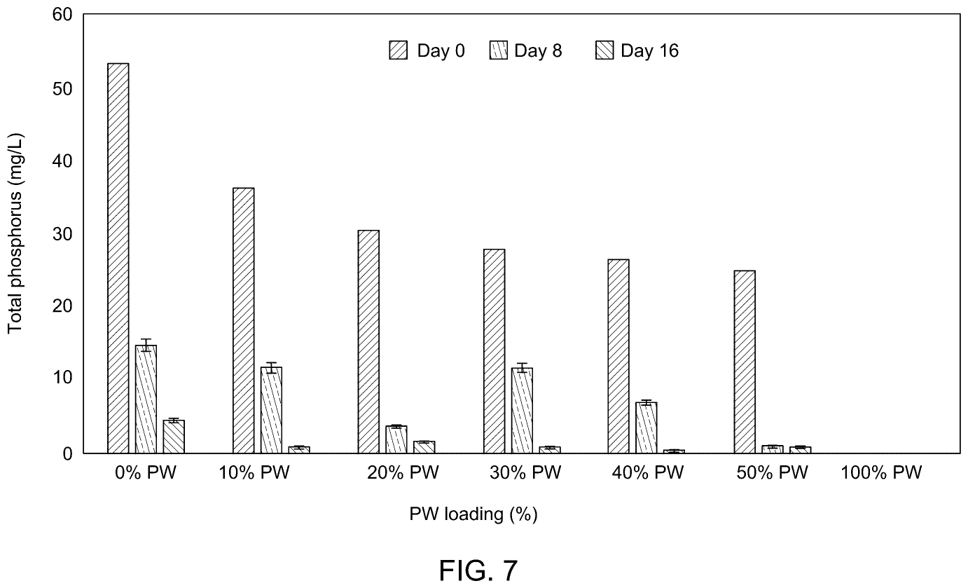

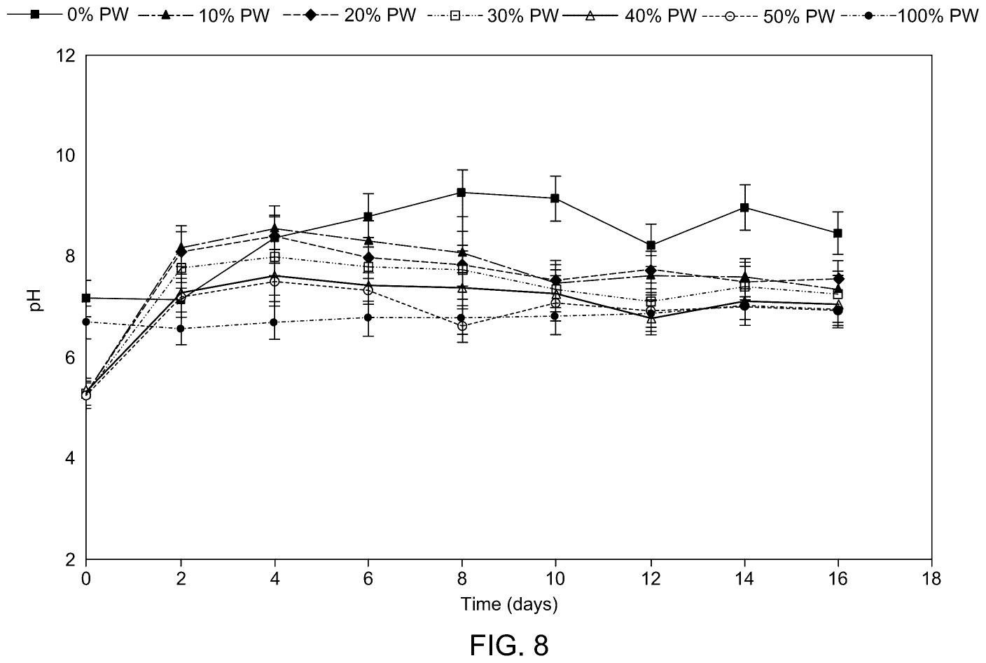

FIG. 7 depicts the total phosphorus (TP) uptake by Chlorella sorokiniana grown under varied levels of PW loadings. As can be seen from FIG. 7, the photobioreactor containing 0%, 10%, 20%, 30%, 40%, and 50% PW loadings showed initial average values for each dilution were 53.24 mg/L, 36.22 mg/L, 30.54 mg/L, 27.8 mg/L, 26.4 mg/L, and 25 mg/L, respectively. The initial values were were reduced to 14.7 mg/L, 11.62 mg/L, 3.52 mg/L, 11.62 mg/L, 6.85 mg/L, and 0.97 mg/L for 0%, 10%, 20%, 30%, 40%, and 50% PW loadings, respectively, on day 8 of the cultivation period. At the end of 16 days of the cultivation period, the concentration of phosphorus reached around 4.4 mg/L, 0.65 mg/L, 1.47 mg/L, 0.65 mg/L, 0.4 mg/L and 0.84 mg/L for 0%, 10%, 20%, 30%, 40%, and 50% PW loadings representing the average removal of 91.7%, 98.2%, 95.2%, 97.7%, 98.5%, and 96.6% of phosphorus, respectively. The average percentage removal of phosphorus for all PW loadings was higher than that of 0% PW (control). The results align with the final biomass concentration of Chlorella sorokiniana at these PW dilutions, as depicted in FIG. 4. The results obtained in FIG. 3 and FIG. 7 indicate that microalgae growth influences the removal of phosphorus from the photobioreactor growing medium. Phosphate may be adsorbed by the microalgal cell wall and then undergo phosphorylation. In the present disclosure, the pH value was estimated to be lower than 9 for all photobioreactors during the cultivation period, as shown in FIG. 8. Hence, the impact of phosphate precipitation is likely negligible in this case due to the pH value of less than 9. Chlorella sorokiniana demonstrated effective nitrogen absorption and successful phosphorus elimination. In comparison to nitrogen uptake, phosphorus was consumed at a great scale than nitrogen in all photobioreactors by Chlorella sorokiniana.

### Example 15: pH Profiles

FIG. 8 depicts the pH profiles over time during the cultivation of Chlorella sorokiniana under different percentages of PW loadings. As shown in FIG. 8, the initial pH values for 10%, 20%, 30%, 40%, and 50% PW loadings were in the range of 5.25-5.34. Initial pH values for 0% PW and 100% PW were 7.19 and 6.71, respectively. The pH adjustment of the culture medium before the autoclave process influences the initial pH values in the photobioreactors with different PW loadings. On day 2 the pH values of the culture medium increased for photobioreactors containing 10%, 20%, 30%, 40%, and 50% PW loadings and were from 7.20 to 8.21. The pH rises were positively correlated with the microalgal growth on day 2, as shown in FIG. 3. There was a slight drop in pH on day 2 of cultivation for 0% PW and 100% PW loadings, which is associated with minimal microalgal growth. After day 2, pH values were maintained at about the same level with minor fluctuations up to day 10 for 10%, 20%, 30%, 40%, and 50% PW loadings, and the pH value were from 7.09 to 8.57. Generally, the trend to neutral and more basic conditions of the culture medium correlates with the exponential growth of microalgae within this duration of culture medium, as shown in FIG. 3. In comparison to other PW loadings, the rise in pH in the comparatively slower growing 0% PW medium (SDW) was higher after day 2. The pH value for 100% PW was leveled off throughout the cultivation period due to the lack of microalgae growth. As seen in FIG. 8, the salinity of the culture medium influences pH variation during the cultivation period. Considering all PW loadings, a higher pH value was observed for lower salinity and vice versa. Overall, the growth curves observed in FIG. 3 for 10%, 20%, 30%, 40%, and 50% PW loadings were corroborated with the trend of higher pH value, as shown in FIG. 8.

### Example 16: Total Lipid Content

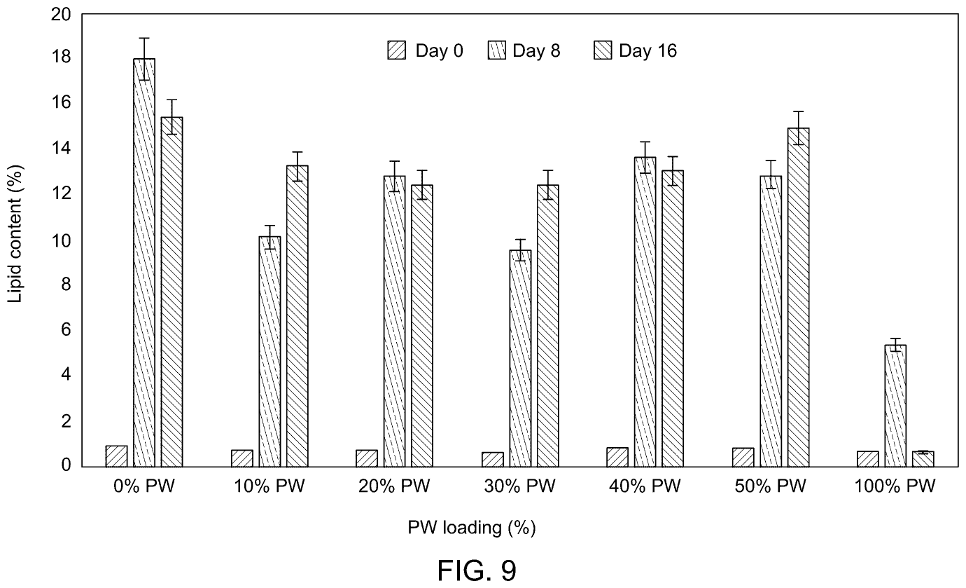

Total lipid content as a percentage of the dry weight of biomass on different days of the cultivation period of the photobioreactors are depicted in FIG. 9. On average, total lipid content varied between 12.42% and 15.41% at the end of the 16-day cultivation period. As seen from FIG. 9, on day 8 of the cultivation period, total lipid content increased in all PW loadings; however, 0% PW loading showed a lipid content of about 17.98%, which is higher than other PW loadings. On day 16, in comparison to day 8, lipid content reduced in 0% PW (15.41%), 20% PW (12.42%), and 40% PW (13.03%), whereas it increased in 10% PW (13.23%), 30% PW (12.46%), and 50% PW (14.94%). It was observed that lipid content increased with an increase in PW loadings at the end of the cultivation period for 20%, 30%, 40%, and 50% PW loadings due to the rise in the C/N ratio with an increase in PW loadings.

Aspects of the present disclosure indicate that Chlorella sorokiniana exhibits potential for utilization in petroleum-derived PW due to its ability to survive in challenging conditions, adapt to varying levels of salinity, effectively remediate pollutants, and generate valuable by-products. The potential for employing freshwater halotolerant microalgae in the bioremediation of organic compounds within produced water was investigated by monitoring total organic carbon (TOC) and nutrient removal to assess the capacity of Chlorella sorokiniana to remediate SPW by bioremediation. The monitoring involved evaluating media with varying volumes of SPW (ranging from 0% to 100% v/v) supplemented with SDW. Maximum TOC removal efficiency on day 8 for different PW loadings was 41.66%, 40.79%, 61.54%, 72.8%, 80.38%, and 84.92% for 0%, 10%, 20%, 30%, 40%, and 50% PW loadings, respectively. Maximum TOC removal efficiency on day 16 for 100% PW was just 6.05% (initial TOC=358.4 mg/L) due to no algae growth. Natural abilities of halotolerant Chlorella sorokiniana microalgae may be harnessed for mitigating dissolved organic carbon in PW, thereby presenting a conducive manner to preserve aquatic ecosystems and human health.

Numerous modifications and variations of the present disclosure are possible in light of the above teachings. It is therefore to be understood that within the scope of the appended claims, the disclosure may be practiced otherwise than as specifically described herein.

1. A method for organic compound removal from a solution, comprising:
extracting one or more hydrocarbons from an underground geologic formation,
wherein the extracting forms a hydrocarbon composition and a produced water,
wherein the produced water comprises at least a portion of the one or more hydrocarbons and one or more salts,
mixing the produced water with a domestic wastewater to form a solution,
contacting a microalgae feedstock with the solution in a bioreactor,
wherein the microalgae feedstock is a Chlorella sorokiniana,
wherein the produced water comprises an acetate,
wherein the domestic wastewater comprises nitrogen and phosphorous,
removing the one or more hydrocarbons, nitrogen, and phosphorous from the solution by algal consumption with the microalgae feedstock,
wherein a total lipid content of the microalgae feedstock is 13 to 17% based on a dry weight of biomass,
wherein the one or more hydrocarbons are removed in an amount of 80 to 90 wt. % based on a total weight of the one or more hydrocarbons in the solution before the removing,
wherein the nitrogen is removed in an amount of 70 to 85 wt. % based on a total weight of the nitrogen in the solution before the removing,
wherein the phosphorous is removed in an amount of 90 to 100 wt. % based on a total weight of the phosphorus in the solution before the removing.

2. The method of claim 1, wherein the contacting occurs for 1 to 20 days.

3. The method of claim 1, wherein the one or more salts are a sodium salt, a calcium salt, a magnesium salt, a potassium salt, a sulfate, and a strontium salt.

4. 4: The method of claim 1, wherein the produced water has a total dissolved solids value of 25,000 milligrams per liter (mg/L) to 25,500 mg/L.

5. The method of claim 1, wherein the produced water has a salinity of 39,200 to 39,600 mg/L.

6. The method of claim 1, wherein the produced water has an electrical conductivity of 50 milli siemens per centimeter (mS/cm) to 70 mS/cm.

7. The method of claim 1, wherein the produced water has a total organic carbon value of 330 to 350 mg/L.

8. The method of claim 1, wherein a volume ratio of the produced water to the domestic wastewater is 5:95 to 55:45 based on a total volume of the solution.

9. The method of claim 1, wherein the microalgae feedstock is preadapted.

10. The method of claim 1, wherein a maximal optical density of the Chlorella sorokiniana at a wavelength of 680 nm is from 3.2 to 5.2.

11. The method of claim 1, wherein a maximum specific growth rate of the Chlorella sorokiniana is from 0.14 to 0.25 day⁻¹.

12. The method of claim 1, wherein a maximum biomass productivity of the Chlorella sorokiniana is from 45 to 55 mg/L per day.

13. The method of claim 1, wherein a biomass output of the Chlorella sorokiniana after 15 to 17 days of contacting is from 700 to 1100 mg/L.

14. The method of claim 1, wherein a total organic carbon removal efficiency after 15 to 17 days of contacting is from 83 to 87 percent based on an initial weight of the one or more organic compounds in the solution.

15. The method of claim 1, wherein a mass ratio of carbon to nitrogen to phosphorous (C:N:P) of 1-10:0.65-0.95:0.75-1.25.

16. The method of claim 1, further comprising:
flowing the solution through a treatment pool having a conical end and a rectangular end,
wherein the solution enters the treatment pool through an apex of the conical end,
wherein at least a portion of the conical end at the apex has a transparent cover,
wherein the treatment pool comprises one or more transparent sheets disposed at different depths of the conical end of the treatment pool,
wherein the microalgae feedstock is attached to the one or more transparent sheets.

17. The method of claim 1, wherein an average removal of phosphorous after 15 to 17 days of contacting is 95 to 99 percent of an initial amount of nitrogen in the solution.

18. The method of claim 1, wherein an initial pH of the solution is from 5.2 to 5.4.

19. The method of claim 1, wherein an initial lipid content of the solution is from 0.5 to 1.5% based on a dry weight of biomass.

20. The method of claim 1, wherein a total lipid count of the solution after 15 to 17 of contacting is from 13 to 16% based on a dry weight of biomass.
